(19) United States
(12) Patent Application Publication
(10) Pub. No.: US 2012/0222777 A1
(43) Pub. Date: Sep. 6, 2012

(54) PROCESS TO MANUFACTURE GRAIN-ORIENTED ELECTRICAL STEEL STRIP AND GRAIN-ORIENTED ELECTRICAL STEEL PRODUCED THEREBY

(75) Inventors: Stefano Fortunati, San Gemini (IT); Giuseppe Abbruzzese, Quadrelli (IT); Lieven Bracke, Sinaai-Waas (BE)

(73) Assignee: Tata Steel IJmuiden B.V., IJmuiden (NL)

(21) Appl. No.: 13/510,589

(22) PCT Filed: Nov. 24, 2010
(86) PCT No.: PCT/EP2010/007101

§ 371 Date: May 24, 2012

(30) Foreign Application Priority Data
Nov. 25, 2009 (EP) 09014686.1
Sep. 22, 2010 (EP) 10010180.7

(51) Int. Cl. C21D 8/02; C22C 38/02; C22C 38/60; C22C 38/04; C22C 38/06; C22C 38/16; C23C 8/26; B32B 15/04

(52) U.S. Cl. 148/208; 148/541; 148/226; 148/318; 148/320

(57) ABSTRACT

A process to manufacture grain-oriented electrical steel (GOES) strip and a product produced by the process are provided. A molten silicon-alloyed steel is continuously cast in a strand having a thickness in the range of from 50 to 100 mm and subjected to hot- rolling in a plurality of uni-directional rolling stands to produce final hot-rolled strip coils having a thickness in the range of from 0.7 to 4.0 mm followed by a continuous annealing the hot-rolled strip, cold rolling, continuous annealing the cold-rolled strip to induce primary recrystallisation and, optionally, decarburization and/or nitriding, coating the annealed strip, annealing the coiled strip to induce secondary recrystallisation, continuous thermal flattening annealing of the annealed strip and coating the annealed strip for electric insulation.

The present invention relates to a process for the manufacture of grain oriented electrical steel strip in which the melt alloy is solidified and immediately hot rolled by a sequence of steps with the purpose of obtaining a very homogeneous distribution of recrystallised grains and second phases particles in the metallic matrix of the hot rolled strips and to simplify the production process while obtaining excellent magnetic characteristics.

Grain oriented electrical steel (GOES) is a class of product used as core material for electrical machines like transformers, generators and other electrical apparatuses. Compared to other electrical steels grades, GOES show a reduction in core losses and an improvement of magnetic permeability. This improvement is the result of the sharp crystallographic texture of the product (“Goss texture” or “cube on edge”) where the easy magnetization direction <001> of the bcc crystal lattice aligns with the rolling direction of the product. This anisotropic character of the magnetic properties of GOES strips is exploited by properly cutting or winding the material in order to fit the designed magnetic flux direction in the transformer core with the rolling direction of the product.

The magnetic characteristics defining GOES materials are the magnetic permeability along the reference direction (magnetization curve in the rolling direction) and the power losses, mainly dissipated as heat, due to the use of alternating current. Typically the power losses are measured at 1.5 and 1.7 Tesla. The power losses are directly proportional to the thickness of the product. The excellent magnetic properties obtainable with these products are determined by the chemical composition of the alloy, by the thickness of the rolled sections, by the microstructure and by the crystallographic texture.

The aim of every existing industrial route for the fabrication of GOES is to obtain a sharp Goss texture in the final product. Goss texture sharpness and related magnetic behaviour are obtained by selective secondary recrystallisation during final annealing. A complex balance between grain size distribution in the primary structure and second phase particle distribution (grain growth inhibitors) must be maintained. The crystallographic texture of the primary structure plays a crucial role in the process because the very few Goss grains present in the primary structure act as nuclei for the large Goss grains in the final microstructure. The higher the cold reduction rate in a later cold rolling step, the sharper the final Goss texture.

In the traditional processing routes, the grain growth inhibitors are precipitated and controlled in size before cold rolling, and a very high temperature slab reheating treatment is required to dissolve the elements to be re-precipitated at the desired size distribution. This high slab reheating temperature is undesirable from a cost, environmental and process point of view.

GOES manufacture starting from thin cast slabs (i.e. slabs <100 mm in thickness) are faced with the problem of the strong inheritance of the solidification microstructure (columnar grains known as “refractory” grains) which are deleterious for the control of the desired texture and homogeneous grain structure before the beginning of the final high temperature annealing. The refractory grains tend to elongate by deformation and recovery due to their relatively large size and the high temperature during hot rolling. One way to overcome this problem is by using a relatively high carbon content in order to activate austenite-ferrite transformation during hot rolling (recrystallisation induced by phase transformation). Unfortunately the occurrence of segregation phenomena during casting and the need to eliminate the higher amount of carbon in the strips by decarburization annealing of the strips at final thickness result in higher production costs.

It is known that thin slab continuous casting mills are suitable for producing magnetic steel sheet due to the advantageous control of temperature made possible by in-line processing of thin slabs. JP2002212639 A describes a method for producing grain oriented magnetic steel sheet, wherein a silicon steel melt is formed into thin steel slabs having a thickness of 30-140 mm. In DE19745445 a silicon steel melt is produced, which is continuously cast into a strand having a thickness of 25-100 mm. The strand is cooled during the solidification process to a temperature not lower than 700° C. and divided into thin slabs. The thin slabs are then homogenised in an in-line homogenisation furnace. The thin slabs, heated in such a manner, are subsequently rolled continuously in a multi-stand hot rolling mill to form hot strip having a thickness of <=3.0 mm. Critical in DE19745445 is that the deformation around 1000° C. is avoided to prevent hot ductility problems during rolling. Despite the extensive proposals for practical use, documented in the prior art, the use of casting mills, wherein typically a strand having a thickness of usually 40-100 mm is cast and then divided into thin slabs, for producing grain oriented magnetic steel sheet remains the exception due to the special requirements, which arise in the production of magnetic steel sheet with respect to molten metal composition and processing control.

It is an object of this invention to provide a low cost process to manufacture grain-oriented electrical steel strip having excellent magnetic properties based on the thin-slab casting technology.

It is also an object of this invention to provide a process to manufacture grain-oriented electrical steel strip based on the thin-slab casting technology with excellent and consistent magnetic properties.

One or more of these objects are reached by the process in accordance with claim 1.

The process is based on the manufacturing of hot rolled strip with thickness in the range of 0.7 to 4.0 mm starting from a molten silicon-alloyed steel which is cast in a continuous casting device to slabs having a thickness in the range of from 50 to 100 mm and having the composition as specified.

The rapid solidification is obtained by continuously casting slabs with a thickness of the final solid strand having a thickness in the range of from 50 to 100 mm. The cast strands are preferably rapidly solidified in less than 300 seconds. If the solidification time is too long, e.g. longer than 300 seconds, segregation phenomena of elements such as Si, C, S, Mn, Cu occur which results in undesired localized inhomogeneities of chemical composition and crystal structures.

The thickness of the cast strand must not be lower than 50 mm to guarantee the sufficient deformation potential during hot rolling.

To produce finished GOES with excellent magnetic properties the molten alloy must have a chemical composition as specified in claim 1.

Increasing the amount of added Si raises the electrical resistance, improving core loss properties. However, if more is added, cold rolling becomes very difficult, with the steel cracking during rolling. At most 4.5% Si is used for production according to the invention. If the amount is less than 2.1%, [symbol] ansformation takes place during finish annealing, which impairs the crystallographic texture.

C is an effective element for controlling primary recrystallisation structure, but also has an adverse effect on magnetic properties, so it is necessary to conduct decarburization before finish annealing. If there is more than 0.1% C, the decarburization annealing time increases thereby impairing productivity. In this invention, acid-soluble Al is a necessary element as it combines with N as (Al, Si)N to function as an inhibitor. The maximum value allowed is 0.07%, which stabilizes secondary recrystallisation. A suitable minimum amount is 0.01%. If there is more than 0.015% N, blisters are produced in the steel sheet during cold rolling, so exceeding 0.015% N is to be avoided. To have it function as an inhibitor, up to 0.010 is required. If the amount exceeds 0.008%, the precipitate dispersion state may become inhomogeneous, producing secondary recrystallisation instability. Consequently, the nitrogen amount preferably is at most 0.008%.

If there is less than 0.02% Mn, cracking occurs more readily during hot rolling. As MnS and MnSe, Mn also functions as an inhibitor. If the manganese content exceeds 0.50%, the dispersions of precipitates may become inhomogeneous, producing secondary recrystallisation instability. The preferable maximum value is 0.35%.

In combination with Mn, S and Se function as inhibitors. If the S and/or Se content exceeds 0.04% the dispersion of precipitates becomes inhomogeneous more readily, producing secondary recrystallisation instability.

Cu is also added as an inhibitor constituent element. Cu forms precipitates with S or Se to thereby function as an inhibitor. The inhibitor function is decreased if there is less than 0.01%. If the added amount exceeds 0.3%, dispersion of precipitates becomes inhomogeneous more readily, producing saturation of the core loss decrease effect.

In addition to the above components, if required, the slab material of the invention may also contain one or more of the nitride forming elements Ti, V, B, W, Zr and Nb. Also it may contain one or more of the elements Sn, Sb and As to maximum total amount of 0.15% and it may contain P and/or Bi to a maximum total amount of 0.03%. P is an effective element for raising specific resistance and decreasing core loss. Adding more than 0.03% may result in cold rolling problems.

Sn, As and Sb are well-known grain boundary segregation elements which prevent oxidation of the aluminium in the steel, for which up to a total amount of 0.15% may be added. Bi stabilises precipitates of sulphides and the like, thereby strengthening the inhibitor function. However, adding more than 0.03% has an adverse effect and should be avoided.

Preferably the metal matrix of the finished sheets has to include as low as possible an amount of elements such as Carbon, Nitrogen, Sulphur, Oxygen which are able to form small precipitates which interact with the motion of the walls of the magnetic domains during the magnetization cycles thereby increasing the losses.

Preferably, except for levels consistent with inevitable impurities, the steel according to the invention does not contain nickel, chromium and/or molybdenum.

According to the invention, it is essential that the core temperature of the cast strand is kept above 900° C. before the beginning of hot rolling in order to keep a certain amount of sulphur and/or selenium and nitrogen in solid solution in the metallic matrix to be available for fine precipitation during rolling. If the core temperature drops below 900° C. then these elements prematurely precipitate in the strand and due to thermodynamic and kinetics reasons an undesirable long times and high temperatures in the tunnel furnace before hot rolling would be required to redissolve the precipitates. In the context of this invention, the core of the strand is defined as the last solidified during the cooling process after casting and constitutes about 50% of the cast mass.

The homogenisation of the temperature of the strand is necessary in order to enable homogeneous hot deformation over the length, width and thickness of the slab.

After homogenising the temperature, the slab is subjected to a first rolling reduction of at least 60% in two or more rolling steps in a roughing stage to obtain a transfer bar wherein the roughing stage consists of at least two uni-directional and consecutive rolling stands and wherein the reduction in the first rolling stand is lower than 40% and wherein the time between consecutive rolling passes in the roughing stage is less than 20 seconds; The term uni-directional is used to clarify that the rolling direction of the material to be rolled is not reversed to ensure that every portion of the material is subjected to the same thermo-mechanical treatment in terms of deformation-time-temperature parameters. This means that the process according to the invention is not possible in a roughing mill relying on the use of a reversible mill used in reversible mode.

The method prescribes hot rolling in two distinct stages. In the first rolling stage, the roughing stage, the cast strand is subjected to a first rolling reduction of the strand of at least 60% in two or more rolling steps in a roughing stage to obtain a transfer bar wherein the roughing stage consists of at least two uni-directional and consecutive rolling stands and wherein the reduction in the first rolling stand is lower than 40%. Lower deformation levels do not guarantee the concentration of lattice energy necessary to activate both the desired amount of recrystallisation and the precipitation of non metallic second phases like sulphides and nitrides useful for the successive grain growth processes. Preferably the first reduction step must be lower than the second reduction step in order to keep the thickness of the material always relatively high before the exit of the last rolling stand of the roughing stage to limit at this phase the cooling of the material during roughing. This is prescribed to optimize the equilibrium between the deformation work applied and the exit temperature of the material from the last stand of the roughing stage. This equilibrium becomes important in view of the desired microstructure modification of the material activated by temperature which occurs during the time necessary to transfer the material from the end of the roughing process down to the beginning of the finishing process.

Furthermore it is imperative that the deformation be applied in a continuous manner i.e. by not reversing the rolling direction (e.g. by reversing the rolling direction using a reversing mill stand) to guarantee substantially identical thermomechanical conditions during rolling along the length of the material. Reversible roughing one or more times during the process is not suitable for the present invention because during reversing rolling different portions of material along the rolling direction experience a different thermomechanical treatment such as deformations at different temperatures, different waiting times between deformations in sequence.

The transfer bar having a temperature in the range of from 950 to 1250° C. is subsequently transferred to a finishing stage wherein the transfer time between exiting the roughing stage and entering the finishing stage is at least 15 seconds and at most 60 seconds. This transfer time is important to activate the recrystallisation process in the deformed material. Time and temperature of the material during transfer from the roughing stage and the finishing stage must be strictly controlled. The temperature must be kept not lower, i.e. higher, than 950° C. for at least 15 seconds to achieve the desired degree of recrystallisation fraction at this stage. The transfer time should not exceed 60 seconds because in that case dissolution and/or growth in size of the precipitated particles (nitrides, sulphides, . . . ) can start to be critical reducing the homogeneity of recrystallisation and grain growth processes during the successive annealing further down the production process. After this intermediate stage the transfer bar is reduced down to the final hot-rolled strip thickness in the finishing stage in one or more uni-directional rolling steps. The term uni-directional has the same meaning as described above. After the finishing stage the final hot-rolled strip is cooled and subsequently coiled. After the finishing stage and prior to the coiling of the final hot-rolled strip the strip may be cut using a flying shear or the like to provide two or more separated individual coils from a single transfer bar and/or cast slab.

The final hot-rolled strip is then subjected to a sequence comprising the subsequent steps of:
continuous annealing the hot-rolled strip at a maximum temperature of 1150° C.
cold rolling the annealed strip to the final cold-rolled thickness in the range of from 0.15 to 0.5 mm by single cold rolling or by double cold rolling with an intermediate continuous annealing;
continuous annealing the cold-rolled strip to induce primary recrystallisation and, optionally, decarburization and/or nitriding, by regulating the chemical composition of the annealing atmosphere;
coating the annealed strip with an annealing separator and coiling the annealed strip;
annealing the coiled strip to induce secondary recrystallisation;
continuous thermal flattening annealing of the annealed strip;
coating the annealed strip for electric insulation.

One important purpose of the annealing of the hot rolled strip is to complete the recrystallisation of the material after the finishing stage to exploit the deformation energy stored in the strip after the rapid cooling before the coiling of the final hot-rolled strip. To obtain finished GOES with excellent magnetic properties the final-hot rolled strip must be continuously annealed at a maximum temperature not exceeding 1150° C. Preferably the heating time from 500° C. to this maximum temperature does not exceed 60 seconds. The strip must preferably reach the maximum annealing temperature rapidly in order to favour recrystallisation versus recovery. Exceeding 1150° C. in the annealing treatment is not convenient because this does not give further advantages in recrystallisation and dissolution and growth of the precipitated particles starts to be significant. The annealing step is followed by cold rolling to the final cold-rolled thickness in the range of from 0.15 to 0.5 mm by single cold rolling or by double cold rolling with an intermediate continuous annealing. Afterwards the cold-rolled material is continuously annealed to induce primary recrystallisation in the material and, if necessary, decarburized and/or nitrided, by regulating the chemical composition of the annealing atmosphere. Decarburization during the recrystallisation annealing is not necessary when the carbon content of the final-hot rolled strip is lower than 50 ppm. If decarburization is desired, then the annealing atmosphere is regulated to be slightly oxidising. A typical oxidising atmosphere for this purpose is a mix of H₂, N₂ and H₂O vapour.

An adjustment of the amount of grain growth inhibitors can be adopted to further increase the magnetic stability of the final products. In this case the addition of grain growth inhibitors into the metallic matrix can be done by injecting nitrogen atoms in the strip from the surface. This can be done during the continuous annealing adding to the annealing atmosphere a nitriding agent, such as NH₃. Many different conditions can be adopted in order to inject the additional desired amount of nitrogen in terms of temperature, time, atmosphere composition and in case also decarburization is adopted, nitriding can be performed concomitantly with decarburization or after decarburization. In the process according to the invention the nitriding treatment is performed in the same continuous annealing line right after the annealing treatment devoted to recrystallisation and eventually decarburization by adopting a dedicated controlled atmosphere comprising NH₃ at a temperature in the range of 750-850° C. Finally the annealed strip is coated by an annealing separator. This annealing separator may be a conventional annealing separator mainly composed of MgO, but alternative annealing separators may be used. The coated strip is then coiled and subjected to Coil annealing to induce secondary recrystallisation in the material, and to continuous thermal flattening annealing and finally optionally coated for electric insulation. In an embodiment, the decarburisation may be performed at a different temperature than the nitriding temperature (see e.g. example 3), wherein the decarburisation may even be performed outside the range of 750-850° C.), but the nitriding treatment has to be performed at a temperature in the range of 750-850° C.

In an embodiment of the invention the molten steel alloy comprises silicon up between 2.5 and 3.5% and/or manganese up to 0.35% and/or aluminium up to 0.05%. If the manganese content exceeds 0.35%, the risk of dispersions of precipitates becoming inhomogeneous increases. The values of silicon between 2.5 and 3.5% provide the best compromise between a raised electrical resistance and stability of the crystallographic texture.

In an embodiment of the invention the transfer bar is reheated between exiting the roughing stage and entering the finishing stage during the sequence of steps of the continuous hot rolling to increase the core temperature of the transfer bar by at least 30° C. This reheating of the transfer bar reduces any temperature fluctuations over the length and/or width of the transfer bar, thereby homogenising the recrystallisation.

In an embodiment of the invention the first roughing stage consists of two uni-directional and consecutive rolling stands and wherein the reduction in the first rolling stand is lower than 40%. This twin-roughing configuration has proved to be advantageous in terms of distribution of the reduction and the ability to maintain a high roughing temperature, thereby promoting the recrystallisation between roughing and finishing.

In an embodiment of the invention the reduction in the second rolling stand is higher than 50%. This way the driving force for the recrystallisation between roughing and finishing is maximised.

In an embodiment of the invention the time between the consecutive rolling passes in the roughing stage is less than 20 seconds. In the present invention the total roughing reduction is preferably applied in less than 20 seconds but more preferably in less than 15 seconds. Preferably, dynamic recovery and recrystallisation phenomena during the roughing should be avoided. By reducing the roughing time the risk of recrystallisation is reduced.

In an embodiment of the invention the distribution of the deformation between the rolling stands is varied from an initial distribution at the start-up of the rolling process of a slab to a final distribution wherein the deformation in the second stand is below 50% in the initial distribution and above 50% in the final distribution. This process overcomes any limitation in the bite angle of the rolling stands during the start of rolling of a new slab. Right after the material is safely running in the bite in the roughing stands, the repartition of the deformation among the roughing stands is adjusted from the initial distribution at the start-up of the rolling process of a slab to a final distribution. The final distribution is maintained until the rolling of the cast strand to a transfer bar is completed.

In an embodiment of the invention the cast strand is divided into multi-coil slabs before rolling which are cut on the fly after hot-rolling to produce two or more coils of final hot-rolled strip of the desired dimensions from each multi-coil slab. In this embodiment the strand is cast into a thin slab and optionally cut to such a length that a plurality of coils of the final hot-rolled strip may be produced from said single slab. This way the rolling process is conducted with the purpose to minimize the actual occurrence along the process of temperature and deformation discontinuities related to the rolling of the head and the tail of slabs and bars. The discontinuities cause shape problems and an inhomogeneous internal structure which are avoided by this embodiment.

In an embodiment homogenisation of the cast strand takes place at a temperature in the range of from 1000 to 1200° C. and/or wherein the transfer bar during the transfer has a temperature in the range of from 950 to 1150° C. to stimulate the recrystallisation.

In an embodiment of the invention the final hot-rolled strip is cooled prior to coiling the strip at a cooling rate of at least 100° C./sec. In this embodiment the cooling rate must be not lower than 100° C./sec to inhibit the recovery of the hot rolled microstructure and to increase the stored lattice energy deriving from the hot deformation process. Such a stored energy in the hot rolled strip will be the necessary driving force for the successive recrystallisation activated by the hot rolled strip annealing. The coiling temperature should preferably lie in the range of from 500 to 780° C. It may be beneficial to limit the coiling temperature to at most 650° C. for the same purpose to avoid a too rapid decrease of the stored energy. Higher temperatures may lead to undesirable coarse precipitations and on the other hand would reduce pickling ability. In order to use higher coiling temperatures of over 700° C. the use of a coiler which is arranged immediately after a compact cooling zone is advisable.

In an embodiment of the invention the cold-rolled strip after decarburisation is subjected to continuous annealing in a nitriding atmosphere and wherein the strip temperature is held in the range of from 750° C. to 850° C.

In an embodiment of the invention the final hot-rolled strip coils have a thickness in the range of at least 1.0 mm and/or at most 3.0 mm.

According to a second aspect, a grain-oriented electrical steels is provided which is produced according to the invention and wherein the final product exhibits peak induction levels at 800 A/m of greater than or equal to 1.80 Tesla, preferably greater than or equal to 1.9 Tesla.

Operating under the claimed conditions allows the producer to reliably obtain hot rolled strip coils of the desired weight and length to optimize physical yield, having a microstructure very homogeneous in terms of grain structure and texture and particularly suitable to control the selective secondary recrystallisation after cold rolling at final thickness.

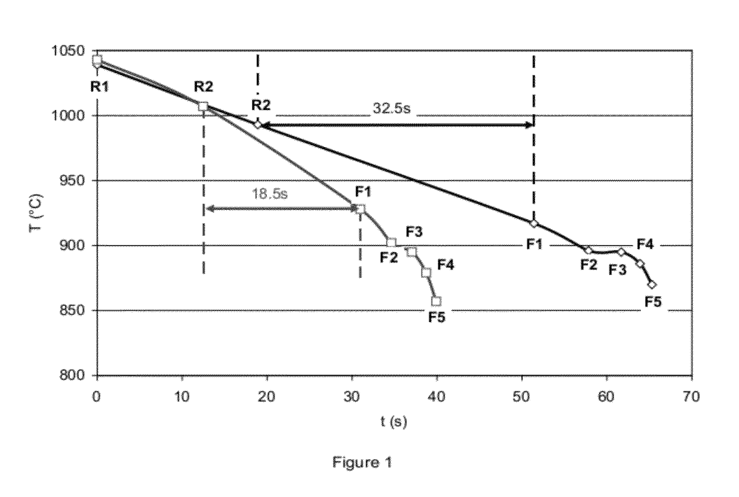

In FIG. 1 the difference between the non-inventive process (open squares, □) and the inventive process (open diamonds, ⋄) is shown. It is clearly visible that the transfer between R2 and F1 in the inventive process takes longer and that the temperature of the slab remains higher for a longer time. The time the slab stays above 950° C., which is essential for the recrystallisation of the deformed slab, is more than 50% longer.

TABLE 1
Some process results of rolling according to invention and not.

| | Inventive | Non-inventive |
|---|---|---|
| | R1 = 37% | R1 = 54% |
| Δ_t(R1,R2) (s) | 18.9 | 12.5 |
| Δ_t(R2,F1) (s) | 32.5 | 18.5 |
| Time above 950° C. during transfer (s) | 19 | 12.5 |

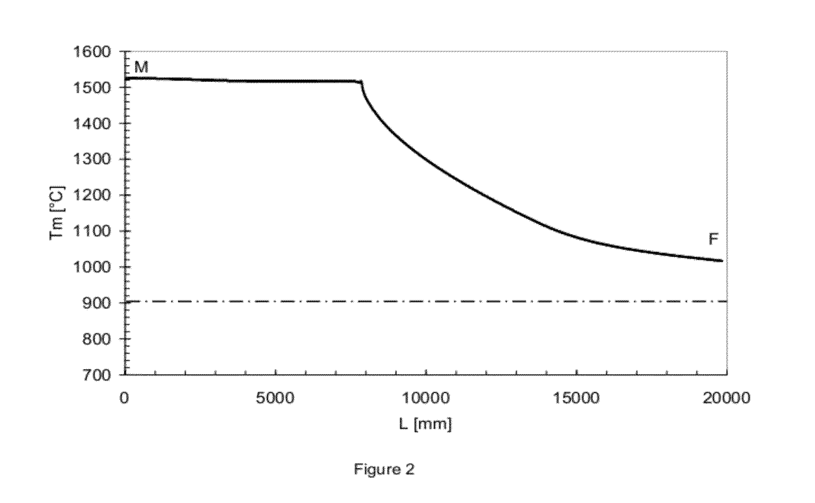

In FIG. 2 the development of the core temperature of the 70 mm strand of the examples below is shown as a function of the distance from the mould at point M up to the entry of the homogenisation furnace at point F cast at a casting speed of 4.8 m/min. It is clearly visible from this figure that the core temperature stays above the critical temperature of 900° C.

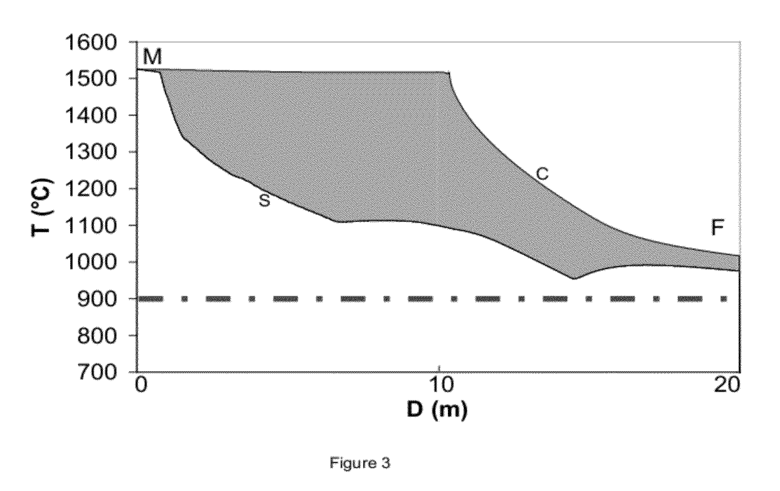

FIG. 3 shows the same curve of FIG. 2 (indicated with C) and a curve representing the temperature of the strand immediately below the surface (indicated with S). It should be noted that the actual surface temperature drops below the temperature of 900° C. when the surface contacts the cooled rolls of the caster or when the strand is contacted by cooling sprays directed at the strand. However, these thermal excursions are very brief in time and the surface temperature quickly recovers to above 900° C. These brief excursions at the immediate surface do not affect the beneficial properties of the final hot rolled strip. The grey surface in FIG. 3 shows the temperatures at points in the strand between the core of the strip and immediately below the surface, indicating that the temperature of the strand is above 900° C. from casting to the entry of the homogenisation furnace. The results presented in FIGS. 2 and 3 can be produced throughout the entire range of casting speeds of from about 3 m/min and higher.

The process according to the present invention will now be illustrated in the following examples which, however, are mere illustrations of the process according to the invention.

### Example 1

A thin slab of 70 mm was cast having a composition of 0.055% C, 3.1% Si, 0.15% Mn, 0.010% S, 0.010% P, 0.025% Al, 0.08% Cu, 0.08% Sn, 0.0070% N, the remainder being iron and unavoidable impurities. The thin slab was homogenised at 1150° C. and rolled in a two stands tandem roughing mill with a reduction in the first rougher of 35% and a reduction in the second stand of 43%. The transfer bar is transferred to the finishing mill and the time between exit of R2 and the entry in F1 is about 25s. The transfer bar is then reduced down to a final hot-rolled strip thickness in a second rolling reduction in a five stand finishing tandem mill. The final hot-rolled strip is cooled at a cooling rate of at least 100° C./sec between the finishing stage and the coiling station and coiled at 640° C. The hot rolled strip was then continuously annealed, pickled and subsequently cold rolling to 0.30 mm by single cold rolling. The cold-rolled strip was annealed to induce primary recrystallisation and decarburization followed by an in-line nitriding treatment in an HNX atmosphere. After subsequent coating the annealed strip with MgO separator and coiling the strip it was annealed again to induce secondary recrystallisation. After continuous thermal flattening annealing of the annealed strip and coating the annealed strip for electric insulation the final product exhibits peak induction levels at 800 A/m of about greater than 1.90 Tesla.

TABLE 2
Composition of the steels (in wt. %, except N in ppm).

| Steel | Ex. | C | Si | Mn | S | P | Al | Cu | Sn | N | Cr | V |
|---|---|---|---|---|---|---|---|---|---|---|---|---|
| 1 | 1 | 0.055 | 3.1 | 0.15 | 0.010 | 0.010 | 0.025 | 0.08 | 0.08 | 70 | n.d. | n.d. |
| 2 | 2-5 | 0.058 | 3.0 | 0.2 | 0.006 | 0.007 | 0.024 | 0.10 | 0.09 | 68 | 0.015 | 0.002 |

### Example 2

Steel 2 has been industrially produced as a melt and solidified in continuous casting at a thickness of about 70 mm followed by thermal homogenisation in a tunnel furnace in line with the caster at a temperature of 1150° C. At the exit of the furnace the solidified strand has been continuously rolled in a two stands tandem roughing mill (see FIG. 1). The strand have been subjected to one of two distinct reduction programs a and b having a different reduction in the first roughing pass of 54 or 37% respectively:
a. R1=70 mm→32 mm (54%)□(FIG. 1), not according to invention).
b. R1=70 mm→44 mm (37%)⋄(FIG. 1), according to invention).

In both cases the reduction in the second stand has been selected such that the total roughing reduction was higher than 65%. The transfer time from the rougher rolling exit (R2) to the finishing rolling start (F1) is 18.5 and 32.5 seconds for the non-inventive and the inventive embodiment respectively. In the subsequent finishing stage hot rolled strip coils having a final hot-rolled strip thickness of 2.3 mm were produced. The coils have been continuously annealed at a temperature of 1110° C. for 90 seconds, cooled and pickled. The coils have been then cold rolled in a single stage and five passes from 2.3 mm to 0.29 mm followed by continuous annealing at 840° C. for a soaking time of about 100 seconds in wet H2-N2 atmosphere for decarburization and after that at 830° C. for a soaking time of about 20 seconds in wet H2-N2-NH3 atmosphere for nitriding. After the annealing treatment the two cold rolled materials were coated with MgO separator and subjected to coil batch annealing to induce secondary recrystallisation. The results are shown in Table 3.

TABLE 3
Results of examples 2 to 5.

| Example | B800 (T) | P17 (W/kg) | |
|---|---|---|---|
| 2a. R1 = 54% | 1.77 | 1.45 | Not according to invention |
| 2b. R1 = 37% | 1.85 | 1.17 | According to invention |
| 3a. R1 = 54% | 1.80 | 1.33 | Not according to invention |
| 3b. R1 = 37% | 1.89 | 1.09 | According to invention |
| 4a. T_nitriding = | 1.89 | 1.09 | According to invention |
| 800° C. | | | |
| 4b. T_nitriding = | 1.60 | 2.05 | Not according to invention |
| 900° C. | | | |
| 5. No nitriding | 1.91 | 1.05 | According to invention |

### Example 3

Cold rolled coils of 0.29 mm of Example 2 of schedule a and b have been continuously annealed at 850° C. for a soaking time of about 100 seconds in wet H2-N2 atmosphere for decarburization and after that annealed at 830° C. for a soaking time of about 20 seconds in wet H2-N2-NH3 atmosphere for nitriding. After the annealing treatment the two cold rolled materials have been coated with MgO separator and subjected to static high temperature annealing to induce secondary recrystallization. The results are shown in Table 3.

### Example 4

Slabs of steel 2 were continuously rolled in a two stands tandem roughing mill, from 70 mm to 45 mm at R1 (36%) and from 45 mm to 24 mm at R2 (46%), i.e. 66% total roughing reduction. The transfer bar was continuously transferred from the rougher rolling mill exit to the finishing rolling mill entrance in 30 seconds and the continuously rolled in a 5-stands finishing mill from 24 mm to a final hot-rolled strip thickness of 2.3 mm.

The hot rolled coils have been annealed in a continuous annealing line at a soaking temperature of 1100° C. for 90 seconds. After pickling the strip has been cold rolled from 2.3 mm to 0.30 mm and then annealed in a second continuous annealing line for decarburization at 850° C. for about 100 seconds in wet H2/N2 atmosphere to reduce carbon content under 30 ppm and in sequence continuously annealed for a nitriding in H2/N2/NH3 atmosphere to increase the nitrogen content of about 30 ppm. The first half of the strip coil has been annealed adopting in the nitriding zone a soaking temperature of 800° C. (4a) while the second half has been annealed adopting in the nitriding zone a temperature of 900° C. (4b). The magnetic properties have been measured after the final annealing in a batch annealing furnace to induce secondary recrystallisation and purify the strip from the residual nitrogen and sulphur. The results are shown in Table 3.

### Example 5

A hot rolled coil produced according to example 2b has been continuously annealed at a temperature of 1000° C. for 60 seconds, cooled and pickled, then cold rolled in a single stage and five passes from 2.3 mm to 0.29 mm of thickness. The cold rolled strip has been then continuously annealed at 800° C. for a soaking time of about 100 seconds in wet H2-N2 atmosphere for decarburization and right after coated with MgO separator (no nitriding!). After the final secondary recrystallisation annealing the finished strips has been characterized by magnetic measurement. The results are shown in Table 3.

1. A process to manufacture grain-oriented electrical steel (GOES) strip wherein a molten silicon-alloyed steel is continuously cast in a strand having a thickness in the range of from 50 to 100 mm, wherein the molten steel alloy comprises:
Silicon 2.1% to 4.5%;
Carbon up to 0.1%;
Manganese 0.02% to 0.5%;
Copper 0.01% to 0.3%;
Sulphur and/or Selenium up to 0.04%;
Aluminium up to 0.07%;
Nitrogen up to 0.015%;
optionally one or more elements selected from one or more of the groups a-c:
a. Titanium, Vanadium, Boron, Tungsten, Zirconium, Niobium to a maximum total amount of 0.05%, and
b. Tin, Antimony, Arsenic to a maximum total amount of 0.15%, and
c. Phosphorous, Bismuth to a maximum total amount of 0.03%;
the remainder being iron and unavoidable impurities;
wherein the solidified strand is hot-rolled in a plurality of uni-directional rolling stands to produce final hot-rolled strip coils having a thickness in the range of from 0.7 to 4.0 mm by a sequence comprising the subsequent steps of:
cooling the solidified strand to a core temperature not lower than 900° C.;
homogenisation of the strand at a temperature in the range of from 1000 to 1300° C.;
a first rolling reduction of the strand of at least 60% in two or more rolling steps in a roughing stage to obtain a transfer bar wherein the roughing stage consists of at least two uni-directional and consecutive rolling stands and wherein the reduction in the first rolling stand is lower than 40% and wherein the time between consecutive rolling passes in the roughing stage is less than 20 seconds;
transfer of the transfer bar having a temperature in the range of from 950 to 1250° C. to a finishing stage wherein the transfer time between exiting the roughing stage and entering the finishing stage is at least 15 seconds and at most 60 seconds to activate the recrystallisation process in the deformed material;
reducing the transfer bar down to final hot-rolled strip thickness in a second rolling reduction in a finishing stage in one or more uni-directional rolling steps;
cooling the final hot-rolled strip between the finishing stage and the coiling station;
coiling the final hot-rolled strip at a coiling temperature in the range of from 500 to 780° C.;
followed by a sequence comprising the subsequent steps of:
continuous annealing the hot-rolled strip at a maximum temperature of 1150° C.
cold rolling the annealed strip to the final cold-rolled thickness in the range of from 0.15 to 0.5 mm by single cold rolling or by double cold rolling with an intermediate continuous annealing;
continuous annealing the cold-rolled strip to induce primary recrystallisation and, optionally, decarburization and/or nitriding at a temperature in the range of 750 to 850° C. by regulating the chemical composition of the annealing atmosphere;
coating the annealed strip with an annealing separator and coiling the annealed strip;
annealing the coiled strip to induce secondary recrystallisation;
continuous thermal flattening annealing of the annealed strip;
coating the annealed strip for electric insulation.

2. The process according to the preceding claim wherein the molten steel alloy comprises:
Silicon 2.5 to 3.5% and/or
Manganese 0.02% to 0.35% and/or
Aluminium up to 0.05%.

3. The process according to claim 1, wherein the transfer bar is reheated between exiting the roughing stage and entering the finishing stage during the sequence of steps of the continuous hot rolling to increase the core temperature of the transfer bar by at least 30° C.

4. The process according to claim 1, wherein the first roughing stage consists of two uni-directional and consecutive rolling stands and wherein the reduction in the first rolling stand is lower than 40%.

5. The process according to claim 1, wherein the reduction in the second rolling stand is higher than 50%.

6. The process according to claim 1, wherein the time between the consecutive rolling passes in the roughing stage is less than 20 seconds.

7. The process according to claim 1, wherein the distribution of the deformation between the rolling stands is varied from an initial distribution at the start-up of the rolling process of a slab to a final distribution wherein the deformation in the second stand is below 50% in the initial distribution and above 50% in the final distribution.

8. The process according to claim 1, wherein the cast strand is divided into multi-coil slabs before rolling which are cut on the fly after hot-rolling to produce two or more coils of final hot-rolled strip of the desired dimensions from each multi-coil slab.

9. The process according to claim 1, wherein homogenisation of the strand takes place at a temperature in the range of from 1000 to 1200° C. and/or wherein the transfer bar during the transfer has a temperature in the range of from 950 to 1150° C.

10. The process according to claim 1, wherein the final hot-rolled strip is cooled prior to coiling the strip at a cooling rate of at least 100° C./sec.

11. The process according to claim 1, wherein the cold-rolled strip after decarburisation is subjected to continuous annealing in a nitriding atmosphere and wherein the strip temperature is held in the range of from 750° C. to 850° C.

12. The process according to claim 1, wherein the final hot-rolled strip coils have a thickness in the range of at least 1.0 mm and/or at most 3.0 mm.

13. A grain-oriented electrical steels produced according to claim 1, wherein the final product exhibits peak induction levels at 800 A/m of greater than or equal to 1.80 Tesla, preferably greater than or equal to 1.9 Tesla.

14. The grain-oriented electrical steels of claim 13, wherein the final product exhibits peak induction levels at 800 A/m of greater than or equal to 1.9 Tesla.
